(19) United States
(12) Patent Application Publication
(10) Pub. No.: US 2003/0233927 A1
(43) Pub. Date: Dec. 25, 2003

(54) Circular saw blade for cutting ferrous materials

(76) Inventors: David N. Johnson, Doncaster (GB); Kelton W. Lovell, Baltimore, MD (US)

Correspondence Address: HARNESS, DICKEY & PIERCE, P.L.C., P.O. BOX 828, BLOOMFIELD HILLS, MI, 48303, US

(21) Appl. No.: 10/175,337

(22) Filed: Jun. 19, 2002

(51) Int. Cl. B23D 61/02

(52) U.S. Cl. 83/835

(57) ABSTRACT

A saw blade having an annular body constructed of a first material having a perimeter with a plurality of teeth formed therein. A plurality of carbide inserts are affixed to a respective tooth. The carbide inserts include a cutting edge including a first edge surface which is generally parallel to an axis of rotation of the blade and a second angled edge surface which is angled relative to the axis of rotation of the blade and shorter than the first edge surface.

### FIELD OF THE INVENTION

The present invention relates generally to circular saw blades, and more particularly to circular saw blades including inserts adapted for cutting ferrous material.

### BACKGROUND

It is known in the art to have saw blades adapted to cut ferrous material such as steel studs. These saw blades may or may not include inserts of a hardened material to increase cutting ability. Generally, saw blades that include inserts have carbide tips that are adapted to tear-away or chop-away small portions of metal at a time.

Generally, these inserts are formed separately and machined or cut before being fit into the saw blade. The machining or forming of the inserts generally includes extensive angles or other shapes being formed into the insert itself. The different forms of the angles and shapes are generally believed to create a greater efficiency in the cutting of a material. However, in creating such numerous indentations and angles in the face or edges of the insert creates additional steps and increased labor in the production of the inserts. Furthermore, an inventory of each individual insert must be kept on hand for saw blade production.

### SUMMARY OF THE INVENTION

The present invention includes a circular saw blade which includes a plurality of teeth situated on the perimeter thereof. Each of the plurality of teeth includes an insert formed of a hardened material, preferably carbide. Each of the inserts includes a leading face which terminates at a cutting edge at the upper radial edge of the insert. The cutting edge is defined by an angled surface which includes a shorter side and a longer side. The inserts are arranged such that adjacent inserts have an alternating pattern such that the shorter side of the angled surface is alternated to different sides of the blade.

Further areas of applicability of the present invention will become apparent from the detailed description provided hereinafter. It should be understood however that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawings, wherein:

FIG. 1 is a plan view of a circular saw blade including carbide inserts on the teeth according to the principles of the present invention;

FIG. 2 is a detail side view of a saw blade tooth;

FIG. 3a is a front detail of a singular insert according to the principles of the present invention; and

FIG. 3b is a top plan view of a single insert according to the principles of the present invention.

### DETAILED DESCRIPTION OF THE PREFERRED EMBODIMENTS

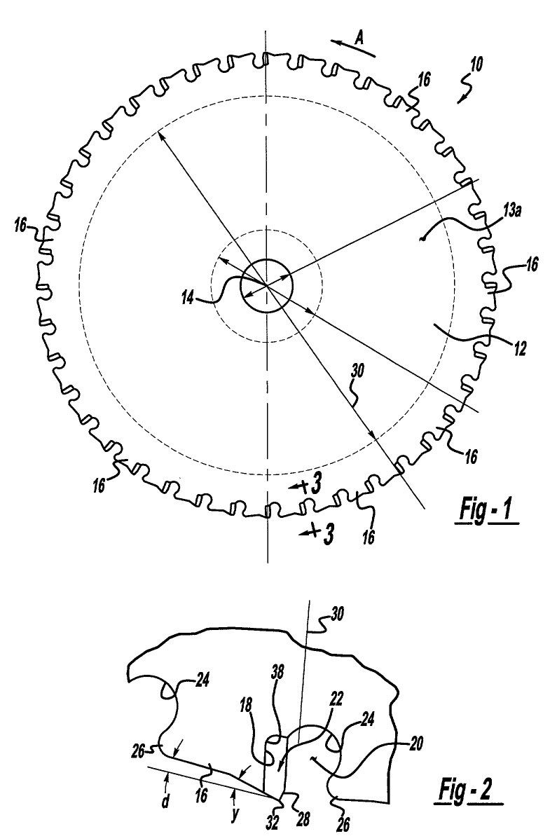

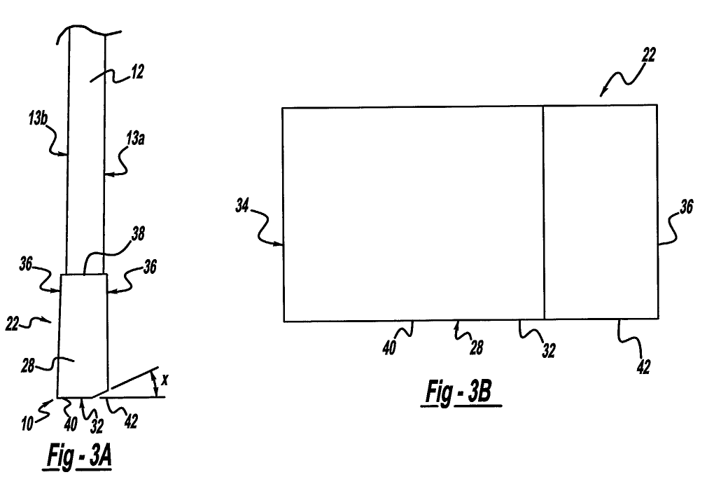

With reference to FIGS. 1-3, a circular saw blade 10 is disclosed. The circular saw blade 10 includes a body 12, having two sides 13a and 13b (only one side is shown in FIG. 1). The saw blade 10 is designed to turn in the direction of arrow A about an axis of rotation 14. Teeth 16 are formed around the perimeter of the body 12. As best shown in FIG. 2, the teeth 16 each include a shoulder 18 each separated by a gullet 20. An insert 22,22′ is affixed to each of the respective shoulders 18. The gullet 20 is an open area that is formed by an arc 24 where a hip 26 of a preceding tooth 16 extends over the arc 24 of the gullet 20. The arc 24 terminates at the leading face 28 of an insert 22. The leading face 28 of the inserts 22,22′ are generally parallel with a radius 30 of the circular saw blade 10. The radius 30 extends from the axis of rotation 14 at the center of the circular saw blade 10. The distal radial edge of the inserts 22,22′ include a cutting edge 32,32′ best shown in FIG. 3, which defines an upper end of the cutting edge of the insert 22.

The inserts 22,22′ are affixed to the tooth 16 through welding, soldering or other suitable means. Thus, the saw blade turns about the axis of rotation 14 in the direction of arrow A so that the leading face 28 of the inserts 22,22′ may engage a material to be cut.

With reference to FIGS. 3 and 3a, the detail of a singular insert 22 is shown. The upper cutting edge of the leading face 28 of the insert 20 includes a cutting edge 32. The insert 22 further includes two sides 34, 36 and a base 38 extending between the sides 34, 36. The cutting edge of the leading face 28 has a width of approximately 1.75 mm with each of the sides 34, 36 tapering inward approximately 0.09 mm at the base end 38. The cutting edge 32 is created by two edge surfaces 40, 42 which terminate into respective sides 34, 36 of the insert 22. The first edge surface 40 is generally perpendicular to the axis of rotation 14 of the blade 10. The second angled edge surface 42 is ground at approximately a 10-30° angle “x”, preferably approximately 20° across approximately one third of the tooth width thus forming angled surface 42. The first and second edge surfaces 40,42 interface along line 43, as best shown in FIG. 3a. The inserts 22′, have a leading face 28 which is a mirror image of the leading face 28 of the inserts 22 and are placed on alternating teeth around the periphery of the saw blade 10. In other words, the angled second edge surface 42 of the cutting edges 32,32′ of inserts 22,22′ respectively are disposed on alternate sides 13a,13b of the blade along the circumference of the circular saw blade 10.

As the circular saw blade 10 rotates about the axis of rotation 14 each alternating cutting edge 32, 32′ takes material from a different side of the channel being cut.

Preferably, the insert 20 is formed of a carbide material including, preferably, 8.6% TiC, 12% Ta(Nb)C, and 9.5% Co. Furthermore, the average preferred grain size of the carbide material would be in the range of 1-1.5 micrometers in diameter.

The cutting edges 32,32′ of the inserts 22,22′ preferably have a back angle “y” of between 5° and 15° and preferably 10°, as illustrated in FIG. 2. The back angle of the inserts 22,22′ leads into a curved upper (or peripheral) surface 44 of the teeth 16. The curved upper surface 44 terminates into the hip 26 which provides a rounded surface transitioning into the arc 24 of the gullet. According to a preferred embodiment, the hip 26 is spaced a distance d from a tangent line of adjacent cutting edge tips 32,32′ of approximately 0.5 mm.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A circular saw blade, comprising:
an annular body constructed of a first material having a perimeter with a plurality of shoulders formed into said perimeter; and
a plurality of inserts each affixed to a respective one of said shoulders, said inserts formed of a second material and including a cutting edge defined along a leading face, each said cutting edge including a first edge surface generally parallel to an axis of rotation of the annular body and including a second angled edge surface between 10° and 30° offset from parallel to an axis of rotation of the annular body.

2. The saw blade according to claim 1, wherein said cutting edge of said inserts include an interface between said first edge surface and said second angled edge surface which is closer to a side of said annular body wherein the interface of adjacent inserts are closer to alternate sides of the annular body.

3. The saw blade according to claim 1, wherein said inserts are formed from carbide.

4. The saw blade according to claim 3, wherein said carbide inserts include approximately 8.6 percent TiC, 12 percent TaNbc, and 9.5 percent Co.

5. The saw blade according to claim 1, wherein said cutting edge of said inserts include a back angle of between 5° and 15°.

6. The saw blade according to claim 5, wherein said back angle is approximately 10°.

7. An insert for a saw blade comprising:
a body portion defining a leading face having a cutting edge, a first and second side, and a bottom edge, said cutting edge defined by a first edge surface extending generally perpendicular from said first side and a second angled edge surface intersecting said first angled surface and extending between 100° and 120° from said second side.

8. The insert according to claim 7, wherein said body portion is made from carbide.

9. The insert according to claim 8, wherein said body portion includes approximately 8.6 percent TiC, 12 percent TaNbC, and 9.5 percent Co.

10. The insert according to claim 7, wherein said cutting edge includes a back angle of between 5° and 15°.

11. The insert according to claim 10, wherein said back angle is approximately 10°.

12. The insert according to claim 7, wherein said second angled edge surface extends at approximately 110° from said second side.
